(19) United States
(12) Patent Application Publication
(10) Pub. No.: US 2021/0276560 A1
(43) Pub. Date: Sep. 9, 2021

(54) VEHICLE CONTROL DEVICE AND VEHICLE CONTROL METHOD

(71) Applicant: HONDA MOTOR CO., LTD., Tokyo (JP)

(72) Inventors: Nozomu HIROSAWA, WAKO-SHI (JP); Yoshifumi NAKAMURA, WAKO-SHI (JP); Takuma KOBAYASHI, WAKO-SHI (JP)

(21) Appl. No.: 17/190,054

(22) Filed: Mar. 2, 2021

(30) Foreign Application Priority Data
Mar. 4, 2020 (JP) 2020-036610

(51) Int. Cl. B60W 30/18; B60W 30/14; B60W 40/09

(52) U.S. Cl. CPC B60W 30/18163; B60W 2540/20; B60W 40/09; B60W 30/143

(57) ABSTRACT

A vehicle control device includes an external environment recognition unit that recognizes a situation of a surrounding periphery of a user's own vehicle, and a lane change control unit that executes an automatic lane change by controlling a travel speed and steering of the user's own vehicle based on a recognition result of the external environment recognition unit. The automatic lane change includes a first lane change (third mode) which is executed regardless of an intention of a driver, and a second lane change (first mode) which is executed in accordance with the intention of the driver. In the case that a request to make the second lane change is detected during execution of the first lane change, the lane change control unit switches the automatic lane change to be executed from the first lane change to the second lane change.

### CROSS-REFERENCE T0 RELATED APPLICATION

This application is based upon and claims the benefit of priority from Japanese Patent Application No. 2020-036610 filed on Mar. 4, 2020, the contents of which are incorporated herein by reference.

### BACKGROUND OF THE INVENTION

### Field of the Invention

The present invention relates to a vehicle control device and a vehicle control method configured to execute an automatic lane change.

### Description of the Related Art

In recent years, there have been developed a driving assisted vehicle in which portions of a travel control of a user's own vehicle are executed regardless of the intention of the driver, and an automatically driven vehicle in which the entirety of the travel control of the user's own vehicle is executed regardless of the intention of the driver. In Japanese Laid-Open Patent Publication No. 2016-071514, a driving assist control device is disclosed in which a lane change proposal is presented to the driver from the side of the vehicle, and an automatic lane change is executed in the case that the driver agrees with the proposal.

As types of automatic lane changes, there are a first lane change that is executed regardless of the intention of the driver, and a second lane change that is executed in accordance with the intention of the driver. Further, in the operation of making the automatic lane change, a predetermined standby time period is set until the user's own vehicle actually starts the operation in relation to making the lane change. The standby time period for the first lane change is a time period for a confirmation to be made by the driver of the surrounding periphery around the user's own vehicle. On the other hand, the standby time period for the second lane change is a time period which is shorter than the first time period, on the premise that the confirmation of the surrounding periphery around the user's own vehicle has been completed by the driver.

### SUMMARY OF THE INVENTION

For example, the driver may perform an operation to instruct that the second lane change be made during the first standby time period for the first lane change. In this case, the driver may experience a sense of discomfort, if the standby time period of a first time period is left set as it is, until the vehicle operation in relation to making the automatic lane change is started. In this manner, in the case that a lane change which is requested by the driver is not implemented, the driver experiences a sense of discomfort.

The present invention has been devised taking into consideration the aforementioned problems, and has the object of providing a vehicle control device and a vehicle control method which are capable of reducing a sense of discomfort experienced by the driver.

One aspect of the present invention is a vehicle control device, comprising an external environment recognition unit configured to recognize a situation of a surrounding periphery of a user's own vehicle; and

a lane change control unit configured to execute an automatic lane change by controlling a travel speed and steering of the user's own vehicle based on a recognition result of the external environment recognition unit,

wherein the automatic lane change includes:

a first lane change which is executed regardless of an intention of a driver; and

a second lane change which is executed in accordance with the intention of the driver, and

wherein, in a case that a request to make the second lane change is detected during execution of the first lane change, the lane change control unit switches the automatic lane change to be executed from the first lane change to the second lane change.

Another aspect of the present invention is a vehicle control method, comprising:

an external environment recognition step of recognizing a situation of a surrounding periphery of a user's own vehicle; and

a lane change control step of executing an automatic lane change by controlling a travel speed and steering of the user's own vehicle based on a recognition result of the external environment recognition step,

wherein the automatic lane change includes:

a first lane change which is executed regardless of an intention of a driver; and

a second lane change which is executed in accordance with the intention of the driver, and

wherein, in the automatic lane change control step, in a case that a request to make the second lane change is detected during execution of the first lane change, the automatic lane change to be executed is switched from the first lane change to the second lane change.

According to the present invention, it is possible to reduce a sense of discomfort experienced by the driver.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram of a vehicle control device;

FIG. 2 is a functional block diagram of a computation device;

FIG. 3 is a diagram showing the behavior of a user's own vehicle that executes a first lane change;

FIG. 4 is a diagram showing the behavior of the user's own vehicle in the case of switching from the first lane change to a second lane change;

FIG. 5 is a diagram showing an operating range of a turn signal lever;

FIG. 6 is a flowchart showing a process flow performed by the vehicle control device; and

FIG. 7 is a flowchart showing a process flow performed by the vehicle control device.

### DETAILED DESCRIPTION OF THE PREFERRED EMBODIMENTS

Preferred embodiments of a vehicle control device and a vehicle control method according to the present invention will be presented and described in detail below with reference to the accompanying drawings.

### [1. Configuration of Vehicle Control Device 10]

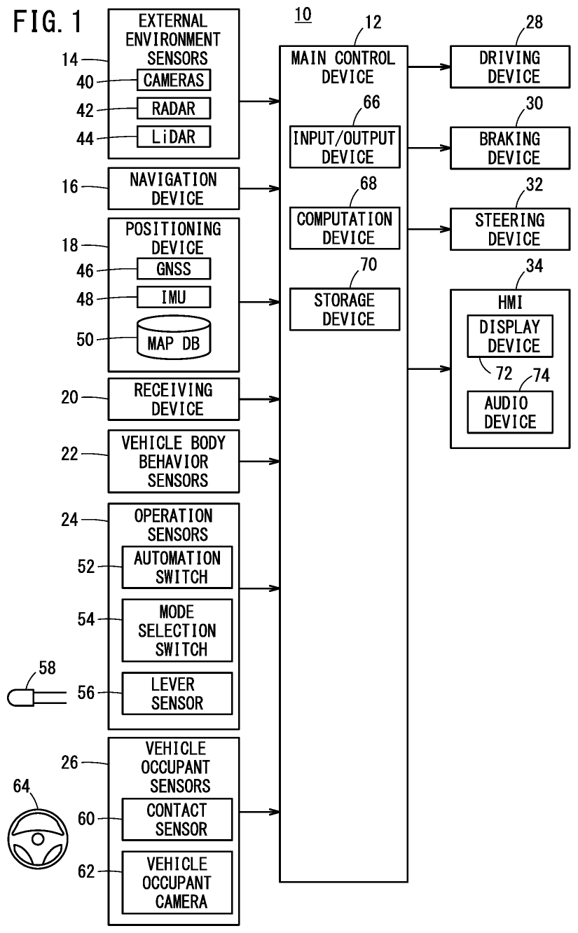

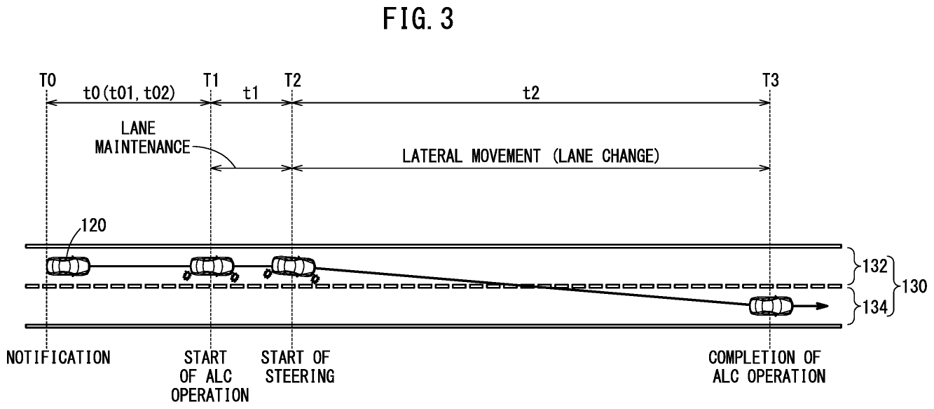

A vehicle control device 10 will now be described with reference to FIG. 1. The vehicle control device 10 is provided in a user's own vehicle 120 (see FIG. 3). The vehicle control device 10 includes a so-called driving assist function that controls the travel speed and the steering of the user's own vehicle 120 regardless of the intention of the driver.

The vehicle control device 10 includes a main control device 12, an input device group that inputs various information to the main control device 12, and an output device group that operates the user's own vehicle 120 based on various information output by the main control device 12. Within the input device group, there are included external environment sensors 14, a navigation device 16, a positioning device 18, a receiving device 20, vehicle body behavior sensors 22, operation sensors 24, and vehicle occupant sensors 26. Within the output device group, there are included a driving device 28, a braking device 30, a steering device 32, and an HMI (Human Machine Interface) 34.

### [1.1. Configuration of Input Device Group]

The external environment sensors 14 include a plurality of cameras 40, a plurality of radar devices 42, and a plurality of LiDAR devices 44. The cameras 40 capture images of the surrounding environment of the user's own vehicle 120, and output image information to the main control device 12. The radar devices 42 and the LiDAR devices 44 detect targets around the periphery of the user's own vehicle 120, and output detected information to the main control device 12.

The navigation device 16 measures the position of the user's own vehicle 120 using GPS, and generates a planned travel route from the position of the user's own vehicle 120 to a destination designated by the driver. The navigation device 16 outputs route information indicating the planned travel route that was generated to the main control device 12.

The positioning device 18 includes a GNSS (Global Navigation Satellite System) 46, an IMU (Inertial Measurement Unit) 48, and a map DB (map database) 50. The positioning device 18 measures the position of the user's own vehicle 120 using the GNSS 46 and the IMU 48, and outputs user's own vehicle position information indicating the position of the user's own vehicle 120 to the main control device 12. Further, the positioning device 18 outputs the map information that is stored in the map DB 50 to the main control device 12. Moreover, the map information stored in the map DB 50 is of higher accuracy than the map information stored in the navigation device 16, and includes various additional information (such as information in lane units, and the like).

The receiving device 20 includes first to third reception terminals (not shown). The first reception terminal receives wide area information broadcast by a broadcasting station. The second reception terminal receives local information transmitted by roadside units installed alongside a road 130 (see FIG. 3). The third reception terminal receives other vehicle information transmitted by other vehicles 122 (see FIG. 3). The first to third reception terminals output various types of received information to the main control device 12.

The vehicle body behavior sensors 22 include respective sensors for measuring behaviors (travel speed, acceleration/deceleration, yaw rate, etc.) of the user's own vehicle 120. The respective sensors output various types of detected information to the main control device 12.

The operation sensors 24 include an automation switch 52, a mode selection switch 54, and a lever sensor 56. In accordance with a switching operation performed by the driver, the automation switch 52 outputs to the main control device 12 instruction information to instruct that automation or cancellation of automation of either the travel speed or the steering be carried out. In accordance with a switching operation performed by the driver, the mode selection switch 54 outputs to the main control device 12 selection information indicating which one of a plurality of driving modes (see item [2] below) has been selected. The lever sensor 56 detects an operated position of a turn signal (blinker) lever 58, and outputs operated position information indicating the operated position of the turn signal lever 58 to the main control device 12. Further, the operation sensors 24 include various sensors that detect operated amounts of operating elements (an accelerator pedal, a brake pedal, and a steering wheel 64).

The vehicle occupant sensors 26 include a contact sensor 60, and a vehicle occupant camera 62. The contact sensor 60 is a capacitance sensor or a pressure sensor provided on the steering wheel 64. The contact sensor 60 detects a gripping state (contact state) of the driver with respect to the steering wheel 64, and outputs the detected information to the main control device 12. The vehicle occupant camera 62 captures images of the driver, and outputs image information to the main control device 12.

### [1.2. Configuration of Main Control Device 12]

The main control device 12 is configured by an ECU. The main control device 12 includes an input/output device 66, a computation device 68, and a storage device 70. The input/output device 66 includes an A/D conversion circuit and a communication interface. The computation device 68 includes a processor such as a CPU. The computation device 68 realizes various functions by executing programs stored in the storage device 70. A description will be given in item [1.4] below concerning the various functions of the computation device 68. The storage device 70 includes a RAM, a ROM, and the like. The storage device 70 stores various programs, and numerical information such as threshold values and the like that are used in processes performed by the computation device 68.

### [1.3. Configuration of Output Device Group]

The driving device 28 includes a driving force output ECU, and control targets (none of which are shown) of the driving force output ECU. The driving device 28 adjusts the driving force in accordance with instruction information (driving instructions) output by the main control device 12.

The braking device 30 includes a brake ECU, and control targets (none of which are shown) of the brake ECU. The braking device 30 adjusts the braking force in accordance with instruction information (braking instructions) output by the main control device 12.

The steering device 32 includes an EPS (Electric Power Steering) ECU, and control targets (none of which are shown) of the EPS ECU. The steering device 32 adjusts a steering amount in accordance with instruction information (steering instructions) output by the main control device 12.

The HMI 34 includes a display device 72 and an audio device 74. The display device 72 outputs images in accordance with instruction information (notification instructions) output by the main control device 12. The audio device 74 outputs audio by way of voice in accordance with instruction information (notification instructions) output by the main control device 12.

### [1.4. Various Functions of the Computation Device 68]

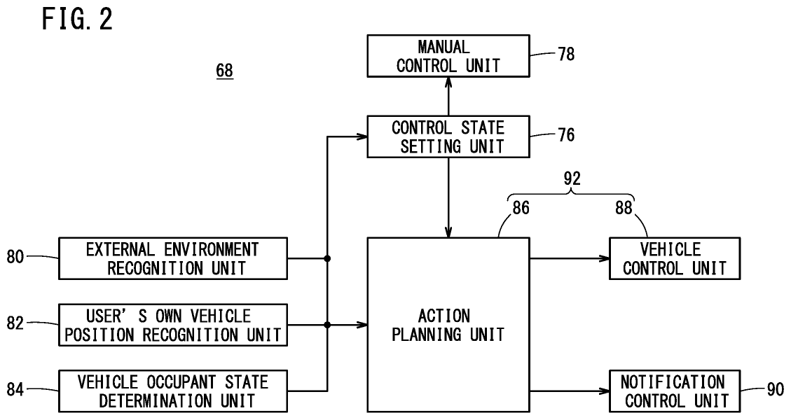

The various functions realized by the computation device 68 will be described with reference to FIG. 2. The computation device 68 functions as a control state setting unit 76, a manual control unit 78, an external environment recognition unit 80, a user's own vehicle position recognition unit 82, a vehicle occupant state determination unit 84, an action planning unit 86, a vehicle control unit 88, and a notification control unit 90. The action planning unit 86 and the vehicle control unit 88 are collectively referred to as a lane change control unit 92.

The control state setting unit 76 determines, in accordance with an operation performed using the automation switch 52, whether to execute various travel controls (control of the travel speed and control of steering) by either one of a manual control or an automatic control. Further, the control state setting unit 76 determines a degree of automation of the automatic control. For example, the control state setting unit 76 selects and sets, from among the plurality of driving modes, the degree of automation to be used when making the lane change. Concerning the automation of making the lane change which is executed in the present embodiment, a description thereof will be given in item [2] below.

The manual control unit 78 performs a travel control in relation to the manual control in accordance with the operated amounts of the operation elements (the accelerator pedal, the brake pedal, and the steering wheel 64) output by the operation sensors 24. The manual control unit 78 outputs instruction information (driving instructions, braking instructions, steering instructions) in relation to the manual control to the driving device 28, the braking device 30, and the steering device 32.

The external environment recognition unit 80 recognizes the situation occurring around the periphery of the user's own vehicle 120, on the basis of the image information and the detected information output by the external environment sensors 14. The user's own vehicle position recognition unit 82 recognizes the position of the user's own vehicle 120, on the basis of the map information and the user's own vehicle position information output by the positioning device 18. The vehicle occupant state determination unit 84 determines the gripping state of the driver (whether or not there is contact made) with respect to the steering wheel 64, on the basis of the detected information output by the contact sensor 60. Further, the vehicle occupant state determination unit 84 recognizes the surrounding monitoring state of the driver (whether or not the driver is looking forward, or whether or not the eyes are open), on the basis of the image information output by the vehicle occupant camera 62.

The action planning unit 86 creates an action plan in relation to the automatic control, on the basis of the recognition result of the external environment recognition unit 80, and the recognition result of the user's own vehicle position recognition unit 82. For example, the action planning unit 86 generates a local map (dynamic map) which includes static information and dynamic information around the periphery of the user's own vehicle 120. In addition, the action planning unit 86 makes a judgment concerning optimal actions based on the local map and the state (travel speed, steering angle, travel position) of the user's own vehicle 120, and determines a travel speed and a travel trajectory in order to realize such actions.

The vehicle control unit 88 performs a travel control in relation to the automatic control in accordance with the action plan. For example, the vehicle control unit 88 calculates an acceleration or deceleration for enabling the user's own vehicle 120 to travel at the travel speed requested by the action planning unit 86. Further, the vehicle control unit 88 calculates a steering angle for enabling the user's own vehicle 120 to travel along the travel trajectory requested by the action planning unit 86. The vehicle control unit 88 outputs instruction information (driving instructions, braking instructions, steering instructions) in relation to the automatic control to the driving device 28, the braking device 30, and the steering device 32. In the case that a notification is generated in the action plan, the notification control unit 90 outputs instruction information (notification instructions) to the HMI 34.

### [2. Automatic Lane Change]

The automatic control of the travel speed and steering in relation to making a lane change is referred to as an automatic lane change. The driving modes for the automatic lane change include a first mode to a third mode. The first mode is a driving mode in which the vehicle control device 10 starts to make the automatic lane change, in accordance with the intention of the driver (indicated by an operation of the turn signal lever 58 or the like). The second mode is a driving mode in which the vehicle control device 10 provides a proposal to make the automatic lane change to the driver regardless of the intention of the driver, and starts to make the automatic lane change in the case that the driver has approved of the proposal. The third mode is a driving mode in which the vehicle control device 10 starts to make the automatic lane change regardless of the intention or approval of the driver. The automatic lane change in the second and third modes is referred to as a first lane change, and the automatic lane change in the first mode is referred to as a second lane change. The degree of automation is higher in the second mode than in the first mode, and further, is higher in the third mode than in the second mode. Hereinafter, in order to facilitate explanation, the automatic lane change will be referred to as an ALC.

[3. Outline of the Present Embodiment]

In the present embodiment, in the case that a request for the second lane change (the ALC of the first mode) is detected when the action planning unit 86 and the vehicle control unit 88 are executing the first lane change (the ALC of the third mode), the action planning unit 86 and the vehicle control unit 88 execute the second lane change instead of the first lane change.

### [3.1. Behaviors of the User's Own Vehicle 120 in the Third Mode]

Behaviors of the user's own vehicle 120 from having decided to execute the ALC of the third mode and until the ALC is completed will be described with reference to FIG. 3. Moreover, in the present embodiment, execution of the ALC implies a standby time period (from time T0 to T1) and a series of vehicle operations in relation to the ALC (from time T1 to T3) that will be described later.

During a lane maintenance control, the action planning unit 86 creates a plan to execute the ALC (third mode) from a first lane 132 to a second lane 134. In this case, at time T0, the action planning unit 86 outputs a notification instruction to the notification control unit 90. In response to the notification instruction, the notification control unit 90 issues a notification to the driver to the effect that the ALC will be executed.

The action planning unit 86 sets the standby time period with time T0 serving as the starting point. The standby time period that is set in this instance is a confirmation time period t0 required in order for the driver to confirm the situation of the surrounding periphery of the user's own vehicle 120. As the confirmation time period t0, there is a first time period t01, which is used when executing the first lane change (the second and third modes), and a second time period t02 (<t01), which is used when executing the second lane change (the first mode). The confirmation time period t0 is stored beforehand in the storage device 70. The action planning unit 86 stands by in preparation for the series of vehicle operations in relation to the ALC, during a period from time T0 until time T1 after the confirmation time period t0.

The action planning unit 86 turns on the turn signal at time T1 after the confirmation time period t0 has elapsed, and causes the series of vehicle operations in relation to the ALC to be started. In this instance, the action planning unit 86 sets a predetermined lane maintenance time period t1 with time T1 serving as the starting point. During a period from time T1 until time T2 after the lane maintenance time period t1, the action planning unit 86 generates a travel speed and a travel trajectory in relation to lane maintenance. The vehicle control unit 88 executes a control in relation to lane maintenance in accordance with the generated travel speed and travel trajectory.

Next, the action planning unit 86 sets a predetermined lane change time period t2 with time T2 serving as the starting point. The vehicle control unit 88 executes a control in relation to making the lane change in accordance with the generated travel speed and travel trajectory. When steering is started at time T2, the user's own vehicle 120 begins to undertake a lateral movement.

At time T3, the action planning unit 86 confirms that the user's own vehicle 120 is traveling in the center of the second lane 134, and once again executes the lane maintenance control.

[3.2. Behaviors of the User's Own Vehicle 120 when Transitioning from the Third Mode to the First Mode]

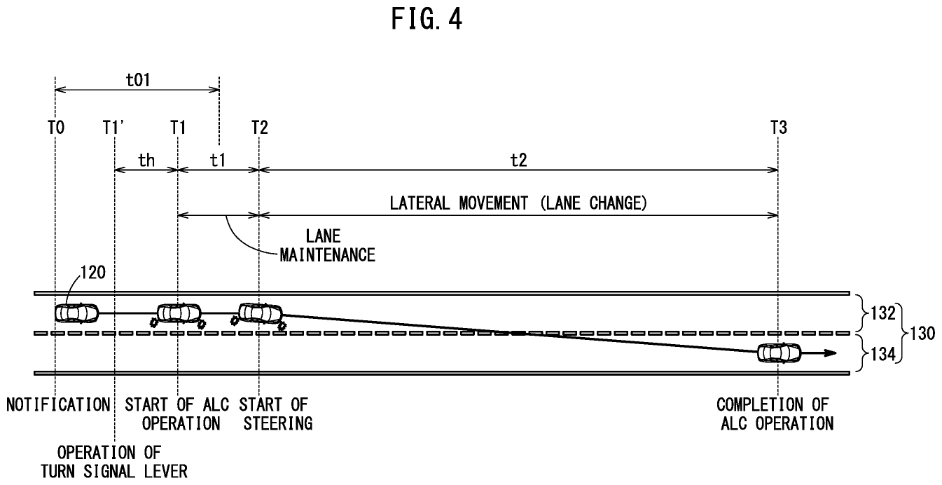

Behaviors of the user's own vehicle 120, in the case of switching from the ALC of the third mode to the ALC of the first mode, after having decided to execute the ALC of the third mode, will be described with reference to FIG. 4.

As described in item [3.1] above, before executing the ALC of the third mode, the action planning unit 86 sets the standby time period with time T0 serving as the starting point. The standby time period that is set is the first time period t01. In this instance, it is assumed that the driver has requested the ALC of the first mode at a point in time (from time T1′ to time T1) before the first time period t01 elapses. For example, as described in item [3.3] below, based on the detection result of the lever sensor 56, the action planning unit 86 detects the request for the ALC of the first mode.

At this time, the action planning unit 86 switches the standby time period from the first time period t01 to the second time period t02. The second time period t02 is a shorter time period than the first time period t01. In the present embodiment, the second time period t02 is zero. In greater detail, in the case of the first mode, at the point in time when the intention of the driver to make the ALC is detected, a series of vehicle operations in relation to the ALC are started.

Therefore, the action planning unit 86 causes the series of vehicle operations in relation to the ALC to be started at T1 before the standby time period of the first time period t01 elapses. The processes thereafter are the same as the processes after time T1 which were described in item [3.1] above. In the foregoing manner, according to the present embodiment, the standby time period is made shorter by switching the ALC from the third mode to the first mode. Stated otherwise, according to the present embodiment, the lateral movement of the user's own vehicle 120 can be started earlier than in the case in which the ALC of the third mode is continued.

### [3.3. Method of Executing the ALC of Third Mode]

According to the present embodiment, the action planning unit 86 determines that the ALC of the first mode is being requested, in the case of detecting a predetermined operation of the turn signal lever 58 performed by the driver. Such a predetermined operation will now be described.

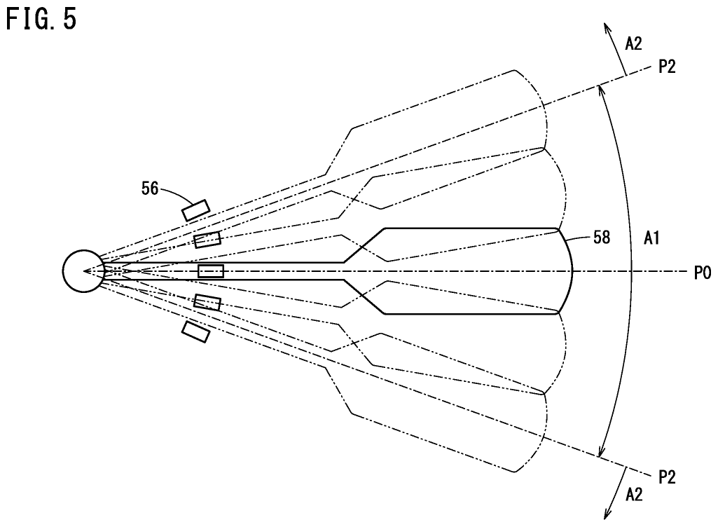

As shown in FIG. 5, the turn signal lever 58 is capable of being swung in one direction and another direction about a neutral position P0. An operating range of the turn signal lever 58 includes a first operating range A1 that extends in the one direction and the other direction about the neutral position P0, and a second operating range A2 that exceeds the first operating range A1. When in the first operating range A1, the turn signal lever 58 receives a force so as to return it to the neutral position P0. On the other hand, when in the second operating range A2, the turn signal lever 58 receives a force so as to be held at a retained position P2.

The lever sensor 56 is constituted by a proximity sensor or the like, and a plurality of the lever sensors 56 are disposed along positions where the turn signal lever 58 is swung. The positions where the turn signal lever 58 is swung are detected based on the detection results of each of the lever sensors 56.

The driver holding the turn signal lever 58 in the first operating range A1 is referred to as a half hold state. As shown in FIG. 4, in the case that the half hold state is continued for a first predetermined time period th or longer, the action planning unit 86 determines that the ALC of the first mode is being requested by the driver. On the other hand, in the case that the turn signal lever 58 is operated in an opposite direction to the direction (to the left or right) of the ALC to be executed by the action planning unit 86, the action planning unit 86 determines that cancellation of the ALC is being requested by the driver.

### [4. Processes Performed by the Vehicle Control Device 10]

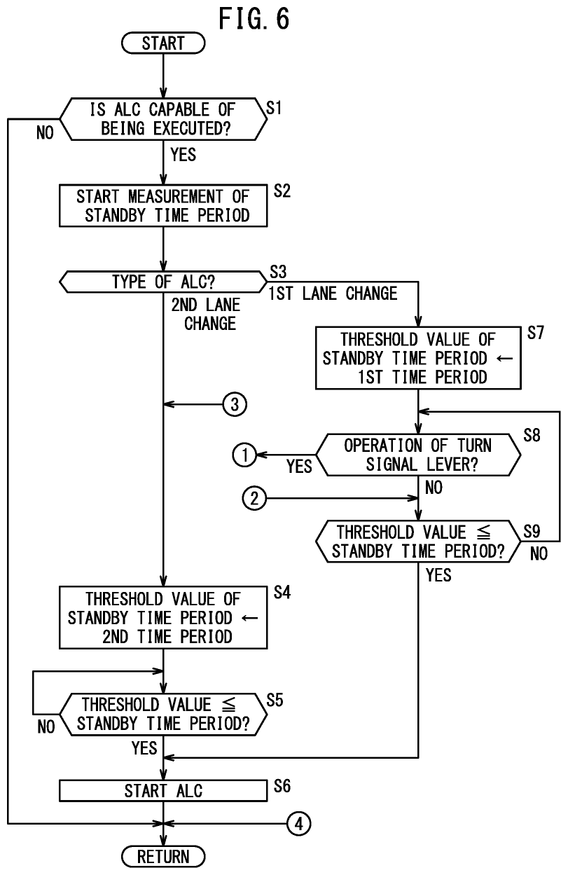

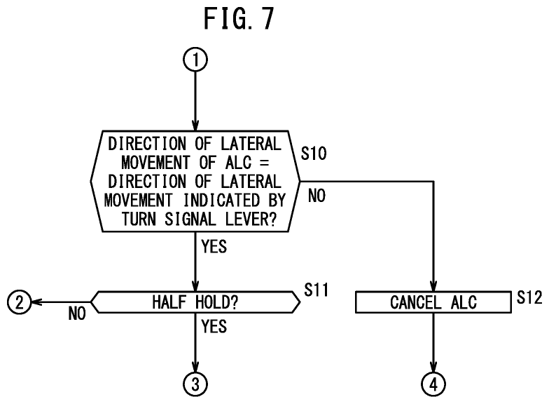

A description will be given with reference to FIGS. 6 and 7 of processes performed by the vehicle control device 10. The processes shown in FIGS. 6 and 7 are executed in predetermined time intervals, in a state in which at least a driving assist function in relation to making the ALC is operating. Moreover, the input device group (the external environment sensors 14, the navigation device 16, the positioning device 18, the receiving device 20, the vehicle body behavior sensors 22, the operation sensors 24, and the vehicle occupant sensors 26) acquires various information at an appropriate timing, and outputs the acquired information to the main control device 12.

In step S1, the action planning unit 86 determines whether or not the ALC is capable of being executed. For example, the action planning unit 86 makes a determination to the effect that the ALC can be executed, in the case it is judged that the ALC is necessary in order to reach the destination, and the environment is such that the ALC can be executed. The environment in which the ALC can be executed is, for example, a situation in which another vehicle 122 is not recognized to be present in the second lane 134. Further, in the case that the lever sensor 56 detects an operation of the turn signal lever 58 toward the side of the second lane 134, and in the case that the environment is such that the ALC can be executed, the action planning unit 86 makes a determination to the effect that the ALC is capable of being executed. In the case that the ALC is capable of being executed (step S1: YES), the process transitions to step S2. On the other hand, in the case that the ALC is not capable of being executed (step S1: NO), one cycle of the main process comes to an end.

In step S2, the action planning unit 86 starts measuring a standby time period using a real-time clock. When the process of step S2 is completed, the process transitions to step S3.

In step S3, the action planning unit 86 determines the type of ALC to be executed. In the case of the ALC of the first mode (second lane change) which is executed in accordance with the intention of the driver (step S3: second lane change), the process transitions to step S4. On the other hand, in the case of the ALC of the third mode (first lane change) which is executed regardless of the intention of the driver (step S3: first lane change), the process transitions to step S7.

### [4.1. ALC of First Mode (Second Lane Change)]

In step S4, the action planning unit 86 sets a threshold value of the standby time period to the second time period t02. In the present embodiment, the second time period t02 is set to zero. Therefore, in the case of the ALC of the first mode, the threshold value of the standby time period is set to zero. When the process of step S4 is completed, the process transitions to step S5.

In step S5, the action planning unit 86 compares the standby time period being measured with a threshold value (second time period t02). In the case that the standby time period is greater than or equal to the threshold value (step S5: YES), and more specifically, if the second time period t02 has elapsed, the process transitions to step S6. On the other hand, in the case that the standby time period is less than the threshold value (step S5: NO), the process of step S5 is repeatedly executed.

In step S6, the action planning unit 86 causes the series of vehicle operations in relation to the ALC to be started. The vehicle control unit 88, in accordance with the action plan established by the action planning unit 86, initiates and executes the control in relation to making the lane change.

### [4.2. ALC of Third Mode (First Lane Change)]

In step S7, the action planning unit 86 sets a threshold value of the standby time period to the first time period t01. In the present embodiment, the first time period t01 is set to be longer than the second time period t02. The point in time at which step S7 is executed corresponds to time T0 in FIG. 3. When the process of step S7 is completed, the process transitions to step S8.

In step S8, based on the detection result of the lever sensor 56, the action planning unit 86 determines whether or not a predetermined operation of the turn signal lever 58 has been made. The process performed in this instance is a process of determining whether or not the ALC of the first mode is intended, by the driver operating the turn signal lever 58 within the standby time period. In the case that the turn signal lever 58 is operated (step S8: YES), the process transitions to step S10 of FIG. 7. On the other hand, in the case that the turn signal lever 58 is not operated (step S8: NO), the process transitions to step S9.

In step S9, the action planning unit 86 compares the standby time period being measured with a threshold value (first time period t01). In the case that the standby time period is greater than or equal to the threshold value (step S9: YES), and more specifically, if the first time period t01 has elapsed, the process transitions to step S6. On the other hand, in the case that the standby time period is less than the threshold value (step S9: NO), the process returns to step S8.

Upon transitioning from step S9 to step S6, the action planning unit 86 causes the series of vehicle operations in relation to the ALC to be started. The vehicle control unit 88, in accordance with the action plan established by the action planning unit 86, initiates and executes the control in relation to making the lane change. The point in time at which step S6 is executed corresponds to a point in time after time T1 in FIG. 3.

[4.3. Switching from Third Mode to First Mode]

In step S10, the action planning unit 86 compares the direction of lateral movement (to the left or right) of the ALC intended to be executed in the third mode with the direction of lateral movement (to the left or right) indicated by the turn signal lever 58. The process performed in this instance is a process of determining whether the driver is intending to switch the mode of the ALC or is intending to cancel the ALC by the operation of the turn signal lever 58. In the case that both of the directions of lateral movement coincide with each other (step S10: YES), the process transitions to step S11. On the other hand, in the case that both of the directions of lateral movement do not coincide with each other (step S10: NO), the process transitions to step S12.

In step S11, the action planning unit 86 determines whether or not the operation of the turn signal lever 58 is a half hold operation for the first predetermined time period th. In the case of the operation being a half hold operation for the first predetermined time period th (step S11: YES), the process transitions to step S4 of FIG. 6. On the other hand, in the case of the operation not being a half hold operation for the first predetermined time period th (step S11: NO), the process transitions to step S9 of FIG. 6. In this case, the operation of the turn signal lever 58 is ignored.

Upon transitioning from step S11 to step S4, the action planning unit 86 switches the threshold value of the standby time period from the first time period t01 to the second time period t02. Then, the action planning unit 86 executes the processes of steps S5 and S6 described above.

In step S12, the action planning unit 86 cancels the ALC. In the case that a decision to cancel the ALC is made, the action planning unit 86 does not execute the ALC, even if the driver requests the ALC of the first mode within a second predetermined time period after the decision to cancel.

### [5. Modified Example]

In the case that the action planning unit 86 detects a request for the ALC of the first mode by an operation of the turn signal lever 58, after the standby time period for the ALC of the third mode, namely, the first time period t01, has elapsed, the request for the ALC of the first mode is not accepted. In this case, the ALC of the third mode is continuously executed.

[6. Technical Concepts Obtained from the Embodiments]

A description will be given below concerning the technical concepts that can be grasped from the above-described embodiments and the modified example.

The one aspect of the present invention is characterized by the vehicle control device 10, comprising the external environment recognition unit 80 that recognizes the situation of the surrounding periphery of the user's own vehicle 120; and

the lane change control unit 92 that executes the automatic lane change by controlling the travel speed and the steering of the user's own vehicle 120 based on the recognition result of the external environment recognition unit 80,

wherein the automatic lane change includes:

the first lane change (third mode) which is executed regardless of the intention of a driver; and

the second lane change (first mode) which is executed in accordance with the intention of the driver, and

wherein, in the case that a request to make the second lane change is detected during execution of the first lane change, the lane change control unit 92 switches the automatic lane change to be executed from the first lane change to the second lane change.

According to the above-described configuration, even during execution of the first lane change, the second lane change is executed in response to the request of the driver, and therefore, a sense of discomfort experienced by the driver can be reduced.

In the one aspect of the present invention,

the predetermined standby time period may be set before the start of the vehicle operation in relation to making the first lane change; and

in the case of switching from the first lane change to the second lane change, the lane change control unit 92 may shorten the standby time period.

In accordance with the above-described configuration, the standby time period until the vehicle operation in relation to making the automatic lane change is started is shortened, and therefore, the sense of discomfort experienced by the driver can be reduced.

In the one aspect of the present invention,

in the first lane change, the first standby time period (first time period t01) may be set before the start of the vehicle operation in relation to making the lane change;

in the second lane change, the second standby time period (second time period t02) may be set before the start of the vehicle operation in relation to making the lane change; and

the second standby time period may be shorter than the first standby time period.

In the one aspect of the present invention, in the case that a request to make the second lane change is detected after elapse of the first standby time period (first time period t01), the lane change control unit 92 need not necessarily accept the request to make the second lane change.

In the one aspect of the present invention, the intention of the driver may be indicated by operation of the turn signal lever 58;

the turn signal lever 58 may be capable of being operated in one direction and another direction about the neutral position P0;

the operating range of the turn signal lever 58 may include the first operating range A1 centered about the neutral position P0, and the second operating range A2 that exceeds the first operating range A1; and

the lane change control unit 92 may execute the second lane change in the case that the turn signal lever 58 is held by the driver in the first operating range A1 for the predetermined time period (first predetermined time period th) or longer.

In the one aspect of the present invention,

in the case that the direction of lateral movement of the first lane change and the direction of lateral movement indicated by the turn signal lever 58 are the same, the lane change control unit 92 may switch the lane change to be executed from the first lane change to the second lane change; and

in the case that the direction of lateral movement of the first lane change and the direction of lateral movement indicated by the turn signal lever 58 are opposite, the lane change control unit 92 may cancel the first lane change.

In the one aspect of the present invention, in the case that a decision to cancel the first lane change is made, the lane change control unit 92 need not necessarily execute the second lane change, even if the driver requests the second lane change within the predetermined time period (second predetermined time period) after the decision to cancel.

The other aspect of the present invention is characterized by the vehicle control method, comprising: the external environment recognition step of recognizing the situation of the surrounding periphery of the user's own vehicle 120; and

the lane change control step of executing the automatic lane change by controlling the travel speed and the steering of the user's own vehicle 120 based on the recognition result of the external environment recognition step,

wherein the automatic lane change includes:

the first lane change (third mode) which is executed regardless of the intention of the driver; and

the second lane change (first mode) which is executed in accordance with the intention of the driver, and

wherein, in the automatic lane change control step, in the case that a request to make the second lane change is detected during execution of the first lane change, the automatic lane change to be executed is switched from the first lane change to the second lane change.

The vehicle control device and the vehicle control method according to the present invention are not limited to the embodiments described above, and it is a matter of course that various modified or additional configurations could be adopted therein without deviating from the essence and gist of the present invention.

What is claimed is:

1. A vehicle control device, comprising:
one or more processors that execute computer-executable instructions stored in a memory,
wherein the one or more processors execute the computer-executable instructions to cause the vehicle control device to:
recognize a situation of a surrounding periphery of a user's own vehicle;
execute an automatic lane change by controlling a travel speed and steering of the user's own vehicle based on a recognition result; and
in a case that a request to make a second lane change, which is executed in accordance with an intention of a driver, is detected during execution of a first lane change, which is executed regardless of the intention of the driver, switch the automatic lane change to be executed from the first lane change to the second lane change.

2. The vehicle control device according to claim 1, wherein the one or more processors cause the vehicle control device to:
set a predetermined standby time period before start of a vehicle operation in relation to making the first lane change; and
in a case of switching from the first lane change to the second lane change, shorten the standby time period.

3. The vehicle control device according to claim 1, wherein:
in the first lane change, a first standby time period is set before start of a vehicle operation in relation to making the lane change;
in the second lane change, a second standby time period is set before the start of the vehicle operation in relation to making the lane change; and
the second standby time period is shorter than the first standby time period.

4. The vehicle control device according to claim 3, wherein, in a case that a request to make the second lane change is detected after elapse of the first standby time period, the one or more processors cause the vehicle control device not to accept the request to make the second lane change.

5. The vehicle control device according to claim 1, wherein:
the intention of the driver is indicated by operation of a turn signal lever;
the turn signal lever is configured to be operated in one direction and another direction about a neutral position;
an operating range of the turn signal lever includes a first operating range centered about the neutral position, and a second operating range that exceeds the first operating range; and
the one or more processors cause the vehicle control device to execute the second lane change in a case that the turn signal lever is held by the driver in the first operating range for a predetermined time period or longer.

6. The vehicle control device according to claim 5, wherein:
in a case that a direction of lateral movement of the first lane change and a direction of lateral movement indicated by the turn signal lever are identical, the one or more processors cause the vehicle control device to switch the lane change to be executed from the first lane change to the second lane change; and
in a case that the direction of lateral movement of the first lane change and the direction of lateral movement indicated by the turn signal lever are opposite, the one or more processors cause the vehicle control device to cancel the first lane change.

7. The vehicle control device according to claim 1, wherein, in a case that a decision to cancel the first lane change is made, the one or more processors cause the vehicle control device not to execute the second lane change even if the driver requests the second lane change within a predetermined time period after the decision to cancel.

8. A vehicle control method, comprising:
recognizing a situation of a surrounding periphery of a user's own vehicle;
executing an automatic lane change by controlling a travel speed and steering of the user's own vehicle based on a recognition result; and
in a case that a request to make a second lane change, which is executed in accordance with an intention of a driver, is detected during execution of a first lane change, which is executed regardless of the intention of the driver, switching the automatic lane change to be executed from the first lane change to the second lane change.
